(19) United States
(12) Patent Application Publication
(10) Pub. No.: US 2016/0244572 A1
(43) Pub. Date: Aug. 25, 2016

(54) Water Dispersible Dendritic Polymers

(71) Applicant: NIPSEA Technologies PTE LTD, Singapore (SG)

(72) Inventors: Shaofeng Wang, Singapore (SG); Jian Hu, Singapore (SG); Chiah Meng Seow, Singapore (SG); Rong Er Lin, Singapore (SG); Jasmine Lim, Singapore (SG); Zeling Dou, Singapore (SG); Swee How Seow, Singapore (SG)

(73) Assignee: NIPSEA Technologies PTE LTD, Singapore (SG)

(21) Appl. No.: 15/028,247

(22) PCT Filed: Dec. 5, 2014
(86) PCT No.: PCT/SG2014/000582

§ 371 Date: Apr. 8, 2016

(30) Foreign Application Priority Data
Dec. 27, 2013 (GB) 1323064.4

(51) Int. Cl. C08G 83/00

(52) U.S. Cl. CPC C08G 83/004

(57) ABSTRACT

The present invention provides a product and a manufacturing process for an aqueous dispersible dendritic polymer with various functionalities, and polymer compositions and polymer formulations comprising such a dendritic polymer. The aqueous dispersible dendritic polymer composition comprises a hydrophilic functional group to allow dispersion in aqueous solvents and improve washability of the polymer, a low surface tension functional group to impart resistance to dirt pick-up and optionally, a curable functional group to allow superior cross-linking capabilities and optionally, a softening functional group to impart flexibility to the composition.

### TECHNICAL FIELD

The present invention generally relates to aqueous dispersible dendritic polymers with various functionalities. The present invention also relates to the method of making such dendritic polymers.

### BACKGROUND

Surfaces, in particular painted surfaces both inside and outside of buildings, may be damaged by elements such as sunlight, water, snow, ice, heat, dirt, smog, humidity, bird droppings, grime, salts, chemicals and acid precipitation. Some of the major technical challenges faced by painted surfaces include: (1) dirt pick-up, which is the accumulation of dirt, dust and/or other debris on the surface, (2) cracking, which is the splitting of the surface through at least one coat due to the expansion and/or contraction of the foundation as a consequence of dynamic climate and weather conditions, and (3) formation of water streak marks, which are marks that are formed on the paint film when water washes down dirt.

Dendritic polymers have been used in the field of manufacturing protective coatings due to its unique structure which leads to the formation of high performance coatings. Dendritic polymers can be hyperbranched to comprise a high number of reactive functional groups exposed at the peripheral edges of the molecule. They can be used to provide coatings of high molecular weight whilst maintaining low viscosity. At the same time, dendritic polymers provide coatings with high cross-link density whilst keeping its flexibility.

Conventionally, dendritic polymers have lacked water solubility, and consequently relied on organic solvents for dissolution prior to mixing and application. However, organic solvents are volatile in nature and coatings applied using organic solvents typically emit an undesirably high level of volatile organic compounds (VOC), which may be flammable, emit an odor and be harmful to health and/or the environment.

Accordingly, water-based coating systems have been proposed to overcome the problem of VOC emission. However, conventional water-based coating systems have poorer properties in terms of hardness and chemical resistance than organic solvent borne coating systems. For example, a dendritic polymer functionalized with hydrophilic ionic functional groups (or “ionomers”) is water dispersible, but has a tendency to undergo phase separation when mixed with cross-linkers, possibly due to incompatibility between the cross-linker and the dendritic polymer. Moreover, such ionomer-functionalized dendrimers suffer from poor homogeneity, resulting in coatings having an uneven surface and exhibiting undesirable blistering, which lead to the coated article having a poor aesthetic appearance.

To overcome the technical challenges of water-based dendritic polymers, addition of surfactant to facilitate improved mixing of the dendritic polymer with aqueous solvents has been proposed. Addition of surfactants is also advantageous as it further improves the dirt pick-up resistance properties of the surface coating by lowering the surface energy such that water repellency, a crucial factor for dirt pick-up resistance, is increased. However, addition of a surfactant can result in an overall softened coating when applied to a surface, which is undesirable in applications where a hard coating is required. Further, surfactants as additives can easily be washed away in the presence of running water, and the desirable properties such as dirt pick-up resistance may become diminished over time.

There is therefore a need to provide an aqueous-dispersible dendritic polymer coating that overcomes, or at least ameliorates, one or more of the disadvantages described above. In particular, there is a need to provide a water-dispersible coating that has a high and extended resistance to dirt pick-up, cracking, and formation of water streak marks, that does not experience phase separation, displays a high level of homogeneity, has excellent film-forming properties, can have variable flexibility, readily undergoes cross-linking and is capable of being rapidly cured after being applied onto a surface. There is also a need to provide a method for producing such an aqueous-dispersible coating.

### SUMMARY

According to a first aspect, there is provided a dendritic polyester polymer comprising low surface tension functional groups, curable functional groups and hydrophilic functional groups; wherein each of the functional groups are functionally different from each other; each of the functional groups are covalently bonded to the dendritic polymer; and the hydrophilic functional groups are present in an amount to render the dendritic polymer dispersible in an aqueous medium.

Advantageously, the dendritic polymer comprises both low surface tension functional groups which impart resistance to water, oil and dirt pick-up and hydrophilic functional groups which impart aqueous dispersibility to the dendritic polymer. The hydrophilic functional groups also improve the washability of dirt, or the ease of dirt-removal of dirt, from the paint film. The low surface tension group imparts resistance to water, oil and dirt pick-up due to their ability to bring the dendritic polymer to the surface of the coating. Further advantageously, the dendritic polymer is substituted with hydrophilic functional groups and low surface tension groups in a sufficient amount to render it aqueous-dispersible while maintaining the dirt pick-up resistance properties. Even further advantageously, since the dendritic polymer is aqueous dispersible, it circumvents the use of potentially harmful volatile organic compounds. The dendritic polymer therefore retains the flexibility and adhesive properties of conventional water-based coatings while having improved resistance to dirt pick-up which was traditionally challenging in water-based coatings.

In one embodiment, the dendritic polymer further comprises curable functional groups. Advantageously, the curable functional groups allow the dendritic polymer to be cross-linked by UV-irradiation, circumventing the need to mix in cross-linking reagents immediately prior to application of the coating comprising the dendritic polymer onto a surface.

In another embodiment, the dendritic polymer further comprises softening functional groups. Advantageously, the softening functional groups allow the dendritic polymer to adopt varying degrees of flexibility and elasticity depending on the practical application of the coating comprising the dendritic polymer.

In another embodiment, any functional group is covalently bonded to the dendritic polymer. Advantageously, since the dendritic polymer may be directly functionalized with the functional groups, the functionalities imparted by the functional groups to the dendritic polymer are not lost over time, unlike when the functionalities are simply mixed in with the dendritic polymer. The properties of the dendritic polymer such as resistance to dirt pick-up and hydrophilicity will therefore by retained for an extended period of time.

In another embodiment, each type of functional groups is different from each other and are independently and covalently bonded onto the dendritic polymer. Advantageously, by each of the functional groups being different from each other, the relative amount of each functional group on the dendritic polymer can be easily controlled. Further advantageously, by each of the functional groups being different from each other, the function which they impart remain independent of each other, allowing further control over the fine-tuning of the property of the dendritic polymer.

According to a second aspect, there is provided a polymer composition comprising the dendritic polymer further comprising at least one additive. Advantageously, the polymer composition may comprise additives that may further improve the physical/chemical properties of the polymer composition, such as photoinitiators, UV-stabilizers and metal oxide nanoparticles, which may improve the cross-linking ability, resistance to UV-degradation and aesthetics as well as resistance to dirt pick-up of the polymer composition, respectively. According to a third aspect, there is provided a method for preparing a dendritic polymer having low surface tension functional groups and hydrophilic functional groups, comprising the steps of; (a) covalently functionalizing the dendritic polymer with low surface tension functional groups using a low surface tension functionalizing agent; and (b) covalently functionalizing the dendritic polymer with hydrophilic functional groups using a hydrophilic functionalizing agent; in an amount to render the dendritic polymer dispersible in an aqueous medium; and (c) covalently functionalizing the dendritic polymer with cross-linking groups using a cross-linking functionalizing agent; each of the functional groups are functionally different from each other.

In one embodiment, the dendritic polymer is functionalized with any functional group via a covalent bond using a functionalizing agent.

Advantageously, the method for preparing the dendritic polymer may comprise the preparation of the functionalizing agents which functionalize the dendritic polymer with the respective functional groups comprising hydrophilic, low surface tension, curable or softening functional groups. Further advantageously, the functional groups may be covalently attached to the dendritic polymer so that the functionalities imparted to the dendritic polymer by the functional groups are not lost over time. Advantageously, by varying the amount of the respective functionalizing agent, the dendritic polymer may be functionalized with the desired amount of the respective functional groups to impart the desired functionalities to the dendritic polymer.

Further advantageously, each functional group is functionalized with a functionalizing agent prior to attaching to the dendritic polymer. This enables the functional groups to be independently and covalently attached to the dendritic polymer. Further advantageously, this process enables control of the relative amount of functional groups to be attached to the dendritic polymer, allowing for fine-tuning of the properties of the functionalized dendritic polymer.

Further advantageously, by functionalizing the curing functional group with a functionalizing agent prior to attaching to the dendritic polymer, the cross-linking reaction can proceed under milder conditions compared to when a cross-linking agent is added to a coating composition comprising the polymer immediately prior to curing the coating. Further advantageously, this may lead to more facile application of coating compositions comprising the dendritic polymer on surfaces.

According to a fourth aspect, there is provided a method for preparing a polymer composition, comprising the step of mixing in at least one additive.

According to a fifth aspect, there is provided a use of the polymer composition to form a coating formulation wherein the coating composition is the sole binder in the coating formulation.

According to the sixth aspect, there is provided a use of the polymer composition to form a coating formulation wherein the composition is an additive in the coating formulation.

Advantageously, a polymer formulation comprising the disclosed dendritic polymer has been shown to have a variety of improved physical/chemical properties. This includes improved aqueous-dispersibility, film-forming properties, oil-repellency, washability, elasticity, hardness, scratch resistance, high and extended resistance to dirt pick-up, resistance to formation of water streak marks and rapid and homogeneous cross-linking abilities.

### DEFINITIONS

The following words and terms used herein shall have the meaning indicated:

The term ‘dendritic polymer’ includes both ‘dendrimers’ and ‘hyperbranched polymers’. In certain embodiments, the term ‘dendritic polymer’ includes solely hyperbranched polymers.

The term ‘dendrimer’ refers to a dendritic polymer having a symmetrical globular shape that results from a controlled process giving an essentially monodisperse molecular weight distribution.

The term ‘hyperbranched polymer’ refers to a dendritic polymer having a certain degree of asymmetry and a polydisperse molecular weight distribution. In certain instances, the hyperbranched polymer has a globular shape. Hyperbranched polymers may be exemplified by those marketed by Perstorp under the Trademarks Boltorn H20™, Boltorn H30™, Boltorn H40™, etc.

The phrase ‘aqueous-dispersible dendritic polymer composition’ is to be used interchangeably with the phrase “water-based dendritic polymer composition” and is taken to refer to a dendritic polymer composition that is either substantially or completely miscible or dispersible in an aqueous medium such as water.

The term ‘hydrophilic’ refers to a material having a tendency to display a higher affinity for water, or readily absorbing or dissolving in water.

The phrase ‘low surface tension’ refers to a material having a surface tension lower than water, which has a surface tension of 72.8 dynes/cm at 20° C. More specifically, ‘low surface tension’ refers to a material having a surface tension lower than 40 dynes/cm at 20° C.

The term ‘curable’ refers to the ability of a polymer material to be hardened or toughened by cross-linking of polymer chains, brought about by chemical additives, ultraviolet radiation, electron beam or heat.

The term ‘softening’ refers to a decrease in hardness or brittleness of a polymer, which leads to an increase in flexibility or the elasticity of the polymer. Specifically, it refers to a decrease in the glass transition temperature (T_{g}).

The phrase ‘dirt pick-up resistance’ can be used interchangeably with ‘resistance to dirt pick-up’ and refers to the surface of the dried coating whereby particles are less likely to become embedded or attached to the coating.

The term ‘room temperature’ refers to any temperature between about 20° C. and about 25° C.

The term ‘upon standing’ or ‘allowed to stand’ can be used interchangeably and refers to the process of allowing a chemical reaction to maintain its state at a certain temperature and pressure without contact with other chemicals and without agitation such as physical mixing.

The term ‘leach out’ refers to the process of removing soluble or other constituents from a substrate by the action of a percolating liquid.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Illustrative, non-limiting embodiments of a dendritic polymer in accordance with the first aspect will now be disclosed.

In one embodiment, a dendritic polyester polymer comprising low surface tension functional groups, curable functional groups and hydrophilic functional groups; wherein each of the functional groups are functionally different from each other; each of the functional groups are covalently bonded to the dendritic polymer; and the hydrophilic functional groups are present in an amount to render the dendritic polymer dispersible in an aqueous medium is discussed.

The dendritic polymer may be used as an additive to a coating material, such as paint. When used in a coating material, the dendritic polymer may be functionalized with low surface tension functional groups to render the dendritic polymer resistant to materials that are foreign to coatings such as oil, water and dirt. That is, the low surface tension functional groups may increase the water- and oil-repellency of the dendritic polymer such that it picks up less dirt. Advantageously, the low surface tension functional groups may render the polymer resistant to dirt pick-up, while the hydrophilic functional groups may render the polymer dispersible in an aqueous medium. Further advantageously, the dendritic polymer may be functionalized with a sufficient amount of hydrophilic functional groups and low surface tension functional groups to render the dendritic polymer aqueous dispersible despite the presence of low surface tension functional groups to maintain its dirt pick-up resistance properties. This may improve the washability of the paint film. Advantageously, since the dendritic polymer may be directly functionalized with the low surface tension functional groups and hydrophilic groups, the functionalities imparted by the functional groups to the dendritic polymer are not lost over time, unlike when these functionalities are simply mixed in with the dendritic polymer.

The dendritic polymer may be a hydroxyl terminated polyester comprising peripheral hydroxyl functional groups. The hydroxyl functional groups may act as functional handles for chemical substitution with molecules that impart properties such as hydrophilicity, low surface tension, curability and softening. The dendritic polymer may have from about 10 to about 80 peripheral hydroxyl groups. The core of the polymer composition may be a 3-dimensional, hyper-branched, dendritic polymer. The dendritic polymer may have a dense spherical structure and a large number of reactive groups at the peripheral surface. In one embodiment, the dendritic polymer may be Boltorn H20™. Boltorn H20™ may be a second generation dendritic polymer that may have a theoretical number of 16 peripheral hydroxyl groups per polymer molecule, with a molecular weight of about 2100 g/mol and hydroxyl number of 490 to 530 mgKOH/g. In another embodiment, the dendritic polymer may be Boltorn H30™. Boltorn H30™ may be a third generation dendritic polymer that may have a theoretical number of 32 peripheral hydroxyl groups per polymer molecule, with a molecular weight of about 3500 g/mol and hydroxyl number of 480 to 520 mgKOH/g. In yet another embodiment, the dendritic polymer may be Boltorn H40™. Boltorn H40™ may be a fourth generation dendritic polymer that may have a theoretical number of 64 peripheral hydroxyl groups per polymer molecule, having a molecular weight of about 5100 g/mol and hydroxyl number of 470 to 500 mgKOH/g. It is generally preferred to have the peripheral hydroxyl group range of about 16 to 64 to provide a sufficient number of peripheral hydroxyl groups for reaction with cross linkers and substitution with hydrophilic groups, and at the same time allow for the ease of forming a film. Dendritic polymers having too many peripheral functional groups may result in the formation of an overly viscous composition, which may encounter problems during film formation. None-the-less, higher generation dendritic polymers having a peripheral functionality of greater than 64, such as 128, may also be envisioned in the scope of the present invention.

At least 10 percent of the peripheral hydroxyl functional groups present on the dendritic polymer may be substituted with hydrophilic groups. Between 10 percent and 50 percent of the peripheral hydroxyl functional groups present on the dendritic polymer may be substituted with hydrophilic groups. Based on the total number of peripheral hydroxyl functional groups, the degree of substitution of these peripheral hydroxyl groups with hydrophilic functional groups may be in the range of about 10 percent to about 50 percent, about 10 percent to about 15 percent, about 10 percent to about 20 percent, about 10 percent to about 25 percent, about 10 percent to about 30 percent, about 10 percent to about 35 percent, about 10 percent to about 40 percent, about 10 percent to about 45 percent, about 15 percent to about 20 percent, about 15 percent to about 25 percent, about 15 percent to about 30 percent, about 15 percent to about 35 percent, about 15 percent to about 40 percent, about 15 percent to about 45 percent, about 15 percent to about 50 percent, about 20 percent to about 25 percent, about 20 percent to about 30 percent, about 20 percent to about 35 percent, about 20 percent to about 40 percent, about 20 percent to about 45 percent, about 20 percent to about 50 percent, about 25 percent to about 30 percent, about 25 percent to about 35 percent, about 25 percent to about 40 percent, about 25 percent to about 45 percent, about 25 percent to about 50 percent, about 30 percent to about 35 percent, about 30 percent to about 40 percent, about 30 percent to about 45 percent, about 30 percent to about 50 percent, about 35 percent to about 40 percent, about 35 percent to about 45 percent, about 35 percent to about 50 percent, about 40 percent to about 45 percent, about 40 percent to about 50 percent or about 45 percent to about 50 percent. This amount of substitution of the peripheral hydroxyl groups on the dendritic polymer with hydrophilic groups may render the functionalized dendritic polymer aqueous dispersible.

In one embodiment, the low surface tension functional groups may comprise at least 0.1 percent by weight of the total non-volatile content. In another embodiment, the low surface tension functional groups may comprise 0.1 percent to 50 percent by weight of the total non-volatile content. In yet another embodiment, the low surface tension functional groups may be 1 percent to 10 percent by weight of the total non-volatile content. In yet another embodiment, the low surface tension functional groups may comprise a range of 1 percent to 5 percent by weight of the total non-volatile content. In yet another embodiment, the low surface tension functional groups may comprise be in the range of about 1 percent to about 2 percent, about 1 percent to about 3 percent, about 1 percent to about 4 percent, about 1 percent to about 5 percent, about 2 percent to about 3 percent, about 2 percent to about 4 percent, about 2 percent to about 5 percent, about 3 percent to about 4 percent, about 3 percent to about 5 percent or about 4 percent to about 5 percent by weight of the total non-volatile content. This amount of substitution of the peripheral hydroxyl groups on the dendritic polymer with low surface tension functional groups may render the functionalized dendritic polymer resistant to dirt pick-up.

The hydrophilic functional group may be selected from a group consisting of primary amino groups, secondary amino groups, tertiary amino groups, quaternary ammonium salt groups, amide groups, carboxyl groups, carboxylate groups, ethylene oxide groups, propylene oxide groups, ester groups, sulfonic acid groups, phosphoric acid groups and hydroxyl groups. In an embodiment, the hydrophilic groups may be carboxylic acid groups, which may be present in a dissociated form (—COO⁻, H⁺) or a non-dissociated form (—COOH).

The low surface tension functional group may have a surface tension lower than water, which has a surface tension of 72.8 dynes/cm at 20° C. More specifically, the low surface tension functional group may have a surface tension lower than 40 dynes/cm at 20° C. The low surface tension functional group may be selected from a group consisting of fluorinated groups and silicon groups. In one embodiment, the fluorinated groups may comprise perfluoroalkyl alcohols. In one embodiment, the fluorinated groups may comprise Fluorolink E10-H™, Lumiflon™ LF200 or 2-(perfluorooctyl)ethanol. In another embodiment, the silicon groups may comprise Baysilone™ OF-OH502 6%. Advantageously, both fluorinated and silicon groups may provide low surface energy, water repellency, oil repellency, lower coefficients of friction and infrared reflection. The low surface energy may help to bring the functionalized dendritic polymer to the surface of the polymer coating.

The dendritic polymer may further comprise curable functional groups. The curable functional groups may be radiation curable cross-linking groups. The radiation curable cross-linking groups may be selected from acrylic or styrene functional groups. The acrylic functional groups may be selected from, but are not limited to, the group consisting of 2-hydroxyethyl acrylate (HEA), 2-hydroxylethyl methacrylate (HEMA), glycidyl methacrylate (GMA), N-(2-hydroxyethyl)acrylamide (HEAA), methacrylamide, N-[3-(dimethylamino)propyl]methacrylamide and any combination thereof.

Advantageously, the presence of the terminal double bonds provided by the acrylic functional groups may aid formation of radicals upon exposure to UV radiation. This may allow for UV curing when the coating formed from the disclosed coating composition is subjected to UV radiation. This may mean that the conventional step of premixing the cross-linking agents into the polymer composition immediately prior to application of a coating composition containing the dendritic polymer onto a surface may not be required. In an embodiment, up to 80 percent of the peripheral hydroxyl functional groups present on the dendritic polymer may be substituted with acrylic functional groups. In an embodiment, up to 40 percent of the peripheral hydroxyl functional groups present on the dendritic polymer may be substituted with acrylic functional groups.

In another embodiment, about 10 percent to about 80 percent of the peripheral hydroxyl functional groups present on the dendritic polymer may be substituted with acrylic functional groups. In another embodiment, about 10 percent to about 40 percent of the peripheral hydroxyl groups present on the dendritic polymer may be substituted with acrylic functional groups. In another embodiment, the peripheral hydroxyl groups present on the dendritic polymer may be substituted with acrylic functional groups in the range of about 10 percent to about 15 percent, about 10 percent to about 20 percent, about 10 percent to about 25 percent, about 10 percent to about 30 percent, about 10 percent to about 35 percent, about 10 percent to about 40 percent, about 15 percent to about 20 percent, about 15 percent to about 25 percent, about 15 percent to about 30 percent, about 15 percent to about 35 percent, about 15 percent to about 40 percent, about 20 percent to about 25 percent, about 20 percent to about 30 percent, about 20 percent to about 35 percent, about 20 percent to about 40 percent, about 25 percent to about 30 percent, about 25 percent to about 35 percent, about 25 percent to about 40 percent, about 30 percent to about 35 percent, about 30 percent to about 40 percent or about 35 percent to 40 percent.

The dendritic polymer may further comprise optional softening functional groups. That is, the softening functional group may impart increased carbon chain length of the functional groups such that the resulting coating film has increased flexibility, which may be especially useful in coating compositions such as paint. For example, in automobile paints, the paint composition should be more rigid relative to paints used to coat the surface of buildings. Hence, the selection of a softening functional group on the dendritic polymer may increase the flexibility of the paint composition. The softening functional groups may contain 4 to, 12 carbons. The softening groups may contain 4 to 6, 4 to 8, 4 to 10, 6 to 8, 6 to 10, 6 to 12, 8 to 10, 8 to 12 or 10 to 12 carbons.

In one embodiment, the softening functional group may be a lactone of a hydroxyl carboxylic acid. In yet another embodiment, the softening functional group may be caprolactone. Advantageously, the presence of the softening functional group such as caprolactone may impart flexibility and anti-crack properties to the polymer composition. Further advantageously, the ring-opening of caprolactone by hydroxyl groups, originating either from the dendritic polymer or from the ring-opened caprolactone, may produce a new hydroxyl group, therefore allowing the total number of hydroxyl groups to remain unchanged on each dendritic polymer following functionalization with caprolactone. In one embodiment, the dendritic polymer may be functionalized with up to 200 percent caprolactone by weight of the dendritic polymer. In another embodiment, the dendritic polymer may be functionalized with about 30 percent to about 200 percent caprolactone by weight of the dendritic polymer. In another embodiment, the dendritic polymer may be functionalized with a range of about 30 percent to about 50 percent, about 30 percent to about 100 percent, about 30 percent to about 150 percent, about 50 percent to about 100 percent, about 50 percent to about 150 percent, about 50 percent to about 200 percent, about 100 percent to about 150 percent, about 100 percent to about 200 percent or about 150 percent to about 200 percent caprolactone by weight of the dendritic polymer. The functionalization with caprolactone may be performed prior to functionalization with any other functional group.

The dendritic polymer may be functionalized with the various functional groups via covalent bonding. Advantageously, the functional groups may be covalently bonded to the dendritic polymer and thereby prevent decoupling of the functional groups therefrom. This may be especially useful in paint compositions, as the functional groups may tend to “leach out” of the paint composition if they are not covalently bonded to the dendritic polymer. That is, it is less likely for the compounds imparting certain functions to the dendritic polymer to be washed away by running water, as they are covalently attached to the cross-linked dendritic polymer. This is in contrast to when additives imparting various properties are merely mixed into the polymer prior to curing, as these additives may slowly “leach out” of the polymer coating when exposed to running water and the properties pertaining to the additives may eventually be diminished or lost. Covalent linkages may comprise isocyanate linkages, ester linkages, ether linkages or amide linkages. The reactive groups that form the linkages may react with the peripheral hydroxyl functional groups on the dendritic polymer.

The disclosed functional groups may be functionally distinct from each other. The hydrophilic functional group, the low surface tension functional group, the curable functional group or the softening functional group may not have the same function. Each of the low surface tension functional groups, the curable functional groups, the hydrophilic functional groups or the softening functional groups may impart a different function, and may be functionally different from each other. That is, the functional groups may not replace each other in terms of function. For example, a hydrophilic functional group may not be used as a curable functional group, and vice versa. Similarly, a low surface tension functional group may not be used as a curable functional group, and vice versa. Alternatively, a hydrophilic functional group may not be be chemically converted to a curable functional group, and vice versa. Similarly, a low surface tension group may not be chemically converted to a curable functional group, and vice versa.

Illustrative, non-limiting embodiments of a polymer composition in accordance with the second aspect will now be disclosed.

A polymer composition comprising the dendritic polymer comprising at least one additive, is discussed. The dendritic polymer may be mixed with additives to enhance its properties as a coating. In one embodiment, this additive may be a photoinitiator. The photoinitiator may be an alpha-hydroxyketone, phenylglyoxylate, benzyldimethyl-ketal, alpha-aminoketone, mono acyl phosphine (MAPO), bis acyl phosphine (BAPO), phosphine oxide, metallocene, an iodonium salt or any combination thereof. In an embodiment, the photoinitiator may be Irgacure® 184 Irgacure® 500, Darocur® 1173, Irgacure® 2959, Darocur® MBF, Irgacure® 754, Irgacure® 651, Irgacure® 369, Irgacure® 907, Irgacure® 1300, Darocur® TPO, Darocur® 4265, Irgacure® 819, Irgacure® 819DW, Irgacure® 2022, Irgacure® 2100, Irgacure® 784, Irgacure® 250, Esacure® DP250 or any combination thereof. In an embodiment, the photoinitiator may be the alpha-hydroxyketone, Irgacure® 500™. Advantageously, the photoinitiator may aid in the cross-linking of the acrylic functional groups functionalized on the dendritic polymer such that upon irradiation with UV, the polymer composition is cured to yield a homogeneously cross-linked coating.

In another embodiment, the additive may be a UV-stabilizer. Advantageously, the UV-stabilizer may prevent the polymer composition from degrading during extended periods of UV-exposure, particularly that from exposure to sunlight. UV stabilizers are used frequently in plastics, including cosmetics and films. The primary function is to protect the substance from the long-term degradation effects of light, most frequently ultraviolet radiation. Different UV stabilizers are utilized depending on the substrate, intended functional life, and sensitivity to UV degradation. UV stabilizers such as benzophenones work by absorbing the UV radiation and preventing the formation of free radicals. Depending on the substituent of the benzophenone, the UV absorption spectrum may be tuned to match the intended application. The concentration of UV-stabilizers in the polymer composition may range from 0.05 percent to 2 percent, with some applications up to 5 percent. The BASF Tinuvin range product contains two types of light stabilizers; Ultraviolet Light Absorbers (WA) and Hindered-Amine Light Stabilizers (HALS), supplied individually or as blends. UVA filter harmful UV light and help prevent color change and delamination of coatings, adhesives and sealants. HALS trap free radicals once they are formed and are effective in retaining surface properties such as gloss and prevent cracking and chalking of paints. The combination of these two chemistries is highly synergistic.

The polymer composition comprising the dendritic polymer may further comprise metal oxide nanoparticles. In an embodiment, the metal oxide nanoparticle may be a titanium dioxide nanoparticle. While not limited to these uses, nanoparticles may be added to the aqueous dispersible polymer composition to impart physical strength, improve wear resistance and durability, increase solids content, improve the ease of cleaning the coating, improve physical appearance, and provide resistance to ultraviolet (UV) degradation. Typically, the nanoparticles may be encapsulated within a polymer which has been suitably functionalized for UV-curability. The titanium dioxide nanoparticles may have a diameter in the range of about 5 nm to about 500 nm. The titanium dioxide nanoparticles may have a diameter in the range of about 10 nm to about 100 nm, about 10 nm to about 25 nm, about 10 nm to about 50 nm, about 10 nm to about 75 nm, about 25 nm to about 50 nm, about 25 nm to about 100 nm, about 50 nm to about 75 nm, about 50 nm to about 100 nm or about 75 nm to about 100 nm.

Illustrative, non-limiting embodiments of a method for preparing a dendritic polymer in accordance with the third aspect will now be disclosed. A method for preparing a dendritic polymer having low surface tension functional groups and hydrophilic functional groups, comprising the steps of; (a) covalently functionalizing the dendritic polymer with low surface tension functional groups using a low surface tension functionalizing agent; and (b) covalently functionalizing the dendritic polymer with hydrophilic functional groups using a hydrophilic functionalizing agent; in an amount to render the dendritic polymer dispersible in an aqueous medium; and (c) covalently functionalizing the dendritic polymer with curable groups using a curable functionalizing agent; each of the functional groups are functionally different from each other, is discussed.

The functionalizing step in steps (a), (b) and (c) may comprise the step of chemically reacting the dendritic polymer with the low surface tension functionalizing agent, the hydrophilic functionalizing agent or the curable functionalizing agent. In one embodiment, the steps (a), (b) and (c) may be performed separately. The steps may not need to be performed in any particular order. In another embodiment, the steps (a), (b) and (c) may be performed concurrently. The reaction may be performed in one-pot. That is, successive chemical reactions may be performed in a single reactor.

In one embodiment, the hydrophilic functionalizing agent may be any compound that reacts to functionalize the dendritic polymer with a hydrophilic functional group. The hydrophilic functionalizing agent is selected to impart the dendritic polymer with hydrophilic functional groups selected from a group consisting of primary amino groups, secondary amino groups, tertiary amino groups, quaternary ammonium salt groups, amide groups, carboxyl groups, carboxylate groups, ethylene oxide groups, propylene oxide groups, ester groups, sulfonic acid groups, phosphoric acid groups and hydroxyl groups. A preferred functional group includes carboxyl functional groups and hence, in one embodiment the hydrophilic functionalizing agent may include monocarboxylic acids, dicarboxylic acids, and anhydrides of aromatic, aliphatic and cycloaliphatic, monocarboxylic and dicarboxylic acids. In a preferred embodiment, the hydrophilic functionalizing agent may be an anhydride of a dicarboxylic acid. The anhydride of a dicarboxylic acid may comprise hexahydrophthalic anhydride (HHPA), maleic anhydride, succinic anhydride or itaconic anhydride. The anhydrides of dicarboxylic acids may react directly with the peripheral hydroxyl functional groups on the dendritic polymers to substitute the hydroxyl groups with carboxylic acid groups through a covalent ester linkage.

In another preferred embodiment, the functionalizing agent may be an isophorone diisocyanate (IPDI) adduct of a molecule comprising a hydrophilic functional group. The molecule comprising a hydrophilic functional group may be N-cyclohexyl-3-aminopropanesulfonic acid (CAPS). The functionalizing agent may be an IPDI adduct of CAPS. The CAPS may be chemically reacted with one of the isocyanate groups of IPDI to form an adduct, which may then be reacted with the dendritic polymer in the presence of a cross-linking catalyst such as dibutylin dilaurate (DBTDL). The second, unreacted isocyanate group on IPDI may react with a peripheral hydroxyl functional group on the dendritic polymer, effectively substituting a hydroxyl functional group with a hydrophilic CAPS group through a covalent isocyanate linkage. The extent of substitution may be controlled by varying the amount of hydrophilic functionalizing agent added to react with the dendritic polymer. That is, if about 10 percent to about 50 percent, about 10 percent to about 15 percent, about 10 percent to about 20 percent, about 10 percent to about 25 percent, about 10 percent to about 30 percent, about 10 percent to about 35 percent, about 10 percent to about 40 percent, about 10 percent to about 45 percent, about 15 percent to about 20 percent, about 15 percent to about 25 percent, about 15 percent to about 30 percent, about 15 percent to about 35 percent, about 15 percent to about 40 percent, about 15 percent to about 45 percent, about 15 percent to about 50 percent, about 20 percent to about 25 percent, about 20 percent to about 30 percent, about 20 percent to about 35 percent, about 20 percent to about 40 percent, about 20 percent to about 45 percent, about 20 percent to about 50 percent, about 25 percent to about 30 percent, about 25 percent to about 35 percent, about 25 percent to about 40 percent, about 25 percent to about 45 percent, about 25 percent to about 50 percent, about 30 percent to about 35 percent, about 30 percent to about 40 percent, about 30 percent to about 45 percent, about 30 percent to about 50 percent, about 35 percent to about 40 percent, about 35 percent to about 45 percent, about 35 percent to about 50 percent, about 40 percent to about 45 percent, about 40 percent to about 50 percent or about 45 percent to about 50 percent substitution of the peripheral hydroxyl functional group of the dendritic polymer is desired with the hydrophilic functional group, an amount of the hydrophilic functionalizing agent equivalent to a range of about 10 OH % to about 50 OH %, about 10 OH % to about 15 OH %, about 10 OH % to about 20 OH %, about 10 OH % to about 25 OH %, about 10 OH % to about 30 OH %, about 10 OH % to about 35 OH %, about 10 OH % to about 40 OH %, about 10 OH % to about 45 OH %, about 15 OH % to about 20 OH %, about 15 OH % to about 25 OH %, about 15 OH % to about 30 OH %, about 15 OH % to about 35 OH %, about 15 OH % to about 40 OH %, about 15 OH % to about 45 OH %, about 15 OH % to about 50 OH %, about 20 OH % to about 25 OH %, about 20 OH % to about 30 OH %, about 20 OH % to about 35 OH %, about 20 OH % to about 40 OH %, about 20 OH % to about 45 OH %, about 20 OH % to about 50 OH %, about 25 OH % to about 30 OH % about 25 OH % to about 35 OH %, about 25 OH % to about 40 OH %, about 25 OH % to about 45 OH %, about 25 OH % to about 50 OH %, about 30 OH % to about 35 OH %, about 30 OH % to about 40 OH %, about 30 OH % to about 45 OH %, about 30 OH % to about 50 OH %, about 35 OH % to about 40 OH %, about 35 OH % to about 45 OH %, about 35 OH % to about 50 OH %, about 40 OH % to about 45 OH %, about 40 OH % to about 50 OH % or about 45 OH % to about 50 OH % of the dendritic polymer, respectively, may be added to the reaction mixture.

In one embodiment, the low surface tension functionalizing agent may be any compound that reacts to functionalize the dendritic polymer with low surface tension functional groups. The low surface tension functional group may comprise fluorinated groups and silicon groups. The low surface tension functionalizing agent may be an isophorone diisocyanate (IPDI) adduct of a molecule comprising a low surface tension functional group. The molecule comprising a low surface tension functional group may comprise perfluoroalkyl alcohols. The molecule comprising a low surface tension functional group may comprise Fluorolink E10-H™, Lumiflon™ LF200, 2-(perfluorooctyl)ethanol or Baysilone™ OF-OH502 6%. The functionalizing agent may be an IPDI adduct of perfluoroalkyl alcohols. The functionalizing agent may be an IPDI adduct of Fluorolink E10-H™, Lumiflon™ LF200, 2-(perfluorooctyl)ethanol or Baysilone™ OF-OH502 6%. The molecule comprising a low surface tension functional group may be chemically reacted with one of the isocyanate groups of IPDI to form an adduct, which may then be reacted with the dendritic polymer in the presence of a cross-linking catalyst such as dibutylin dilaurate (DBTDL). The second, unreacted isocyanate group on IPDI may react with a peripheral hydroxyl functional group on the dendritic polymer, effectively substituting a hydroxyl functional group with a low surface tension functional group through a covalent isocyanate linkage. The extent of substitution may be controlled by varying the amount of low surface tension functionalizing agent added to react with the dendritic polymer. That is, if functionalization with low surface tension functional groups in the range of about 1 percent to about 2 percent, about 1 percent to about 3 percent, about 1 percent to about 4 percent, about 1 percent to about 5 percent, about 1 percent to about 10 percent, about 2 percent to about 3 percent, about 2 percent to about 4 percent, about 2 percent to about 5 percent, about 2 percent to about 10 percent, about 3 percent to about 4 percent, about 3 percent to about 5 percent, about 3 percent to about 10 percent, about 4 percent to about 5 percent, about 4 percent to about 10 percent or about 5 percent to about 10 percent by weight of the total non-volatile content of the dendritic polymer is desired, then an amount of the low surface tension functionalizing agent equivalent to a range of about 1 percent to about 2 percent, about 1 percent to about 3 percent, about 1 percent to about 4 percent, about 1 percent to about 5 percent, about 1 percent to about 10 percent, about 2 percent to about 3 percent, about 2 percent to about 4 percent, about 2 percent to about 5 percent, about 2 percent to about 10 percent, about 3 percent to about 4 percent, about 3 percent to about 5 percent, about 3 percent to about 10 percent, about 4 percent to about 5 percent, about 4 percent to about 10 percent or about 5 percent to about 10 percent by weight of the total non-volatile content, respectively, may be added to the reaction mixture.

Non-volatile content may be determined according to ASTM D1353—13 which describes the analytical measurements of residual matter in solvents that are intended to be 100 percent volatile at 105±5° C. Volatile solvents are used in the manufacture of paint, varnish, lacquer, and other related products, and the presence of any residue may affect the product quality or efficiency of the process. This test method may be useful in manufacturing control and assessing compliance with specifications. Specifically, the sample may be accurately weighed (W₁, about 0.5 g) and placed in a 105° C. oven for 1 hour and the weight of the remaining sample (W₂) may be recorded. Non-volatile %=W₂/W₁×100%.

In one embodiment, the curable functionalizing agent may be any compound that chemically reacts to functionalize the dendritic polymer with curable functional groups. The curable functionalizing agent may be an isophorone diisocyanate (IPDI) adduct of a molecule comprising a curable functional group. The curable functional groups may be radiation curable cross-linking groups. The radiation curable cross-linking groups may comprise acrylic or styrene functional groups. The molecule comprising a curable functional group may comprise 2-hydroxyethyl acrylate (HEA), 2-hydroxylethyl methacrylate (HEMA), glycidyl methacrylate (GMA), N-(2-hydroxyethyl)acrylamide (HEAA), methacrylamide or N-[3-(dimethylamino)propyl]methacrylamide. The curable functionalizing agent may be an isophorone diisocyanate (IPDI) adduct of 2-hydroxyethyl acrylate (HEA), 2-hydroxylethyl methacrylate (HEMA), glycidyl methacrylate (GMA), N-(2-hydroxyethyl)acrylamide (HEAA), methacrylamide or N-[3-(dimethylamino)propyl]methacrylamide. The molecule comprising a curable functional group may be chemically reacted with one of the isocyanate groups of IPDI to form an adduct, which may then be reacted with the dendritic polymer in the presence of a cross-linking catalyst such as dibutylin dilaurate (DBTDL). The second, unreacted isocyanate group on IPDI may be reacted with the peripheral hydroxyl functional groups on the dendritic polymer, effectively substituting a hydroxyl functional group with a curable functional group through a covalent isocyanate linkage. The extent of substitution may be controlled by varying the amount of curable functionalizing agent added to react with the dendritic polymer. That is, if about 10 percent to about 15 percent, about 10 percent to about 20 percent, about 10 percent to about 25 percent, about 10 percent to about 30 percent, about 10 percent to about 35 percent, about 10 percent to about 40 percent, about 15 percent to about 20 percent, about 15 percent to about 25 percent, about 15 percent to about 30 percent, about 15 percent to about 35 percent, about 15 percent to about 40 percent, about 20 percent to about 25 percent, about 20 percent to about 30 percent, about 20 percent to about 35 percent, about 20 percent to about 40 percent, about 25 percent to about 30 percent, about 25 percent to about 35 percent, about 25 percent to about 40 percent, about 30 percent to about 35 percent, about 30 percent to about 40 percent or about 35 percent to 40 percent substitution of the peripheral hydroxyl functional group of the dendritic polymer is desired with the curable cross-linking group, an amount of the curable cross-linking functionalizing agent equivalent to a range of about 10 OH % to about 15 OH %, about 10 OH % to about 20 OH %, about 10 OH % to about 25 OH %, about 10 OH % to about OH %, about 10 OH % to about 35 OH %, about 10 OH % to about 40 OH %, about 15 OH % to about 20 OH %, about 15 OH % to about 25 OH %, about 15 OH % to about 30 OH %, about 15 OH % to about 35 OH %, about 15 OH % to about 40 OH %, about OH % to about 25 OH %, about 20 OH % to about 30 OH %, about 20 OH % to about 35 OH %, about 20 OH % to about 40 OH %, about 25 OH % to about 30 OH %, about 25 OH % to about 35 OH %, about 25 OH % to about 40 OH %, about 30 OH % to about 35 OH %, about 30 OH % to about 40 OH %, or about 35 OH % to about 40 OH % of the dendritic polymer, respectively, may be added to the reaction mixture.

In one embodiment, a softening functionalizing agent may be any compound that chemically reacts to functionalize the dendritic polymer with softening functional groups. In one embodiment, the softening functional group may be a lactone of a hydroxyl carboxylic acid. In a preferred embodiment, the softening functional group may be caprolactone. The caprolactone may react directly with the peripheral hydroxyl functional groups on the dendritic polymer to substitute the hydroxyl groups with an extended chain hydroxyl functional group through a covalent ester linkage. The ring-opening of caprolactone by hydroxyl groups, originating either from the dendritic polymer or from the ring-opened caprolactone, may produce a new hydroxyl group, therefore allowing the total number of hydroxyl groups to remain unchanged on each dendritic polymer. The extent of substitution may be controlled by varying the amount of curable functionalizing agent added to react with the dendritic polymer. That is, if the dendritic polymer is to be functionalized with a range of about 30 percent to about 50 percent, about 30 percent to about 100 percent, about 30 percent to about 150 percent, about 50 percent to about 100 percent, about 50 percent to about 150 percent, about 50 percent to about 200 percent, about 100 percent to about 150 percent, about 100 percent to about 200 percent or about 150 percent to about 200 percent of caprolactone by weight of the dendritic polymer, then an amount of the softening functionalizing agent equivalent to the range of about 30 percent to about 50 percent, about 30 percent to about 100 percent, about 30 percent to about 150 percent, about 50 percent to about 100 percent, about 50 percent to about 150 percent, about 50 percent to about 200 percent, about 100 percent to about 150 percent, about 100 percent to about 200 percent or about 150 percent to about 200 percent, respectively, by weight of the dendritic polymer may be added to the reaction mixture. The substitution of peripheral hydroxyl functional groups on the dendritic polymer with softening functional groups may be performed prior to functionalization with any other functional groups.

The method for preparing a dendritic polymer may comprise the step of providing a hydrophilic functionalizing agent, a low surface tension functionalizing agent, a curable functionalizing agent or a softening functionalizing agent. The providing step may comprise reacting a functional group with a reactive group such as IPDI to form an IPDI adduct of a molecule comprising a functional group. The providing step may be performed prior to functionalizing the dendritic polymer. That is, the providing step may be performed independently of the presence of the dendritic polymer. The functionalizing step may be performed prior to curing the polymer. The providing step provides the individual functional groups independently of each other. That is, the providing step does not involve chemical conversion of one functional group to another functional group.

The method for preparing a dendritic polymer may comprise the step of contacting the hydrophilic functionalizing agent, the low-surface tension functionalizing agent, the curable functionalizing agent or the softening functionalizing agent with the dendritic polymer. The contacting step for each functionalizing agent may be performed independently of each other, or in the presence of each other. The contacting step may result in the functional groups being covalently bonded to the dendritic polymer. The contacting step may be performed in the presence of a catalyst such as dibutylin dilaurate (DBTDL).

Not all peripheral hydroxyl functional groups of the dendritic polymer may chemically react to become functionalized with a functional group following chemical reaction with functionalizing agents such as the hydrophilic functionalizing agent, low surface tension functionalizing agent, curable functionalizing agent or the softening functionalizing agent. Peripheral hydroxyl functional groups on the dendritic polymer may partially remain unreacted.

The disclosed method may further comprise a step of at least partially neutralizing the dendritic polymer with a base. Where the dendritic polymer has been functionalized with a carboxylic acid, the neutralization may be undertaken with any suitable base capable of neutralizing the carboxylic acid group. Exemplary bases may comprise primary amines, secondary amines, tertiary amines or cyclic amines. Exemplary bases may comprise, but are not limited to, ammonia, triethylamine (TEA), AMP 95®, dimethylaminoethanol (DMEA), potassium hydroxide, calcium hydroxide or sodium hydroxide. The neutralization step may be undertaken until the pH of the system containing the dendritic polymer and base is about 7 to about 8. Advantageously, after neutralization, the hydrophilic functional groups on the dendritic polymer may ionize. The ionic form of the functional group may enhance the miscibility and dispersibility of the polymer composition in an aqueous medium.

Illustrative, non-limiting embodiments of a method for preparing a polymer composition in accordance with the fourth aspect will now be disclosed.

In one embodiment, the method further comprising the step of mixing in at least one additive may comprise physical blending, for example, using a mechanical blender. The physical blending may be undertaken at room temperature (i.e. cold blending) using a mechanical mixer. The additive may comprise the aforementioned photoinitiator, UV-stabilizer or metal oxide nanoparticle, or a mixture thereof.

In the disclosed use according to the fifth aspect, the disclosed composition may be used to form a coating formulation wherein the coating composition is the sole binder in the coating formulation. Advantageously, the coating formulation may not require the use of other binders in substantial amounts. The use of the polymer composition may comprise the application of the coating composition on its own to a surface and curing it by UV-irradiation to form a coating for the surface. Advantageously, the coating may serve as a protective coating for the surface or to improve aesthetics of the surface.

In the disclosed use according to the sixth aspect, the disclosed polymer composition may be used to form a coating formulation wherein the composition is an additive in the coating formulation. The use of the polymer composition may comprise mixing or physical blending of the coating composition comprising the dendritic polymer with a substrate such as indoor, outdoor or Elastomeric latex paint. The coating formulation may be applied to a surface then allowed to cure by exposure to UV-radiation. Advantageously, the coating formulation comprising the dendritic polymer functionalized with low surface tension functional groups and hydrophilic functional groups may impart improved resistance to dirt pick-up, washability, oil-repellency, better aesthetics and film forming properties to the substrate.

The coating formulation comprising the polymer composition as the sole binder or as an additive in the coating formulation may have a water contact angle less than 60°. The water contact angle may be less than 50°, less than 40°, less than 30°, less than 20° or less than 10°. The coating formulation comprising the polymer composition as the sole binder or as an additive in the coating formulation may have a hexadecane contact angle greater than 50°. The hexadecane contact angle may be greater than 60°, greater than 70°, greater than 80° or greater than 90°. The coating formulation comprising the polymer composition as the sole binder or as an additive in the coating formulation may have a water contact angle less than 60° and a hexadecane contact angle greater than 50°. The coating formulation comprising the polymer composition as the sole binder or as an additive in the coating formulation may have a water contact angle less than 60° and a hexadecane contact angle greater than 60°.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a schematic diagram showing a polyhydroxyl functional dendritic polymer.

FIG. 2 is a schematic diagram showing a polyhydroxyl functional dendritic polymer substituted with caprolactones.

FIG. 3 is a schematic diagram showing a multi-functionalized dendritic polymer

FIG. 4 is a schematic diagram showing a multi-functionalized dendritic polymer substituted with carboxyl, acrylate and fluorocarbon functional groups.

FIG. 5(a) to (d) shows photographs comparing the effect of addition of the dendritic polymer composition to the dirt-resistance properties of elastomeric paint.

### DETAILED DESCRIPTION OF DRAWINGS

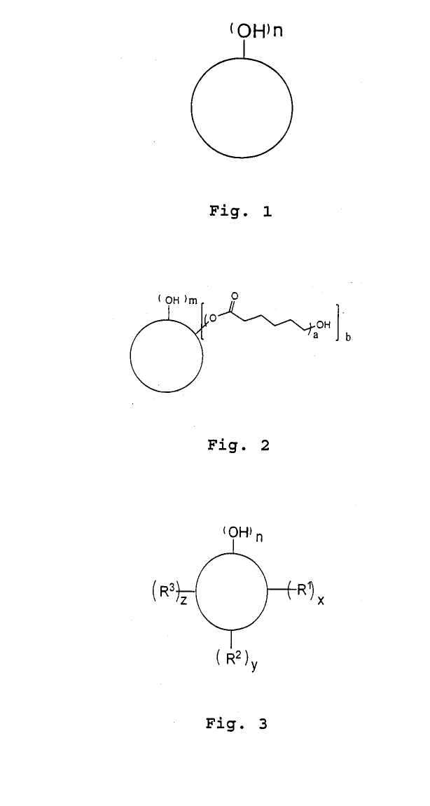

FIG. 1 is a schematic diagram showing a polyhydroxyl functional dendritic polymer, with the ideal number of hydroxyl (OH) groups (n) 16, 32 and 64 for Boltorn H20™, Boltorn H30™ and Boltorn H40™, respectively.

FIG. 2 is a schematic diagram showing a polyhydroxyl functional dendritic polymer substituted with caprolactones. “m” is the number of hydroxyl groups which are not substituted by caprolactone, “b” is the number of ring-opened, linear chains of caprolactone attached to the dendritic polymer and “a” is the number of ring-opened caprolactone in each linear chain. The total hydroxyl groups on the dendritic polymer remains unchanged upon substitution, i.e. the sum of “m” and “b” equals the original number of hydroxyl groups on the dendritic polymer. “m” is a non-negative integer, “a” and “b” are positive integers and the total number of caprolactone units is the sum of products of “a” and “b”.

FIG. 3 is a schematic diagram showing a multi-functionalized dendritic polymer. “n” is the number free hydroxyl groups, “R¹”, “R²”,and “R³” are three different functional groups substituting the hydroxyl groups, respectively and “x”, “y”, and “z” are the number of each functional groups, respectively. “n” is a nonnegative integer, “x”, “y”, and “z” are positive integers. The sum of “n”, “x”, “y”, and “z” equals the original number of hydroxyl groups on the dendritic polymer.

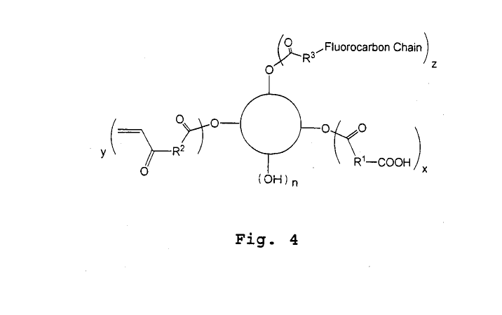

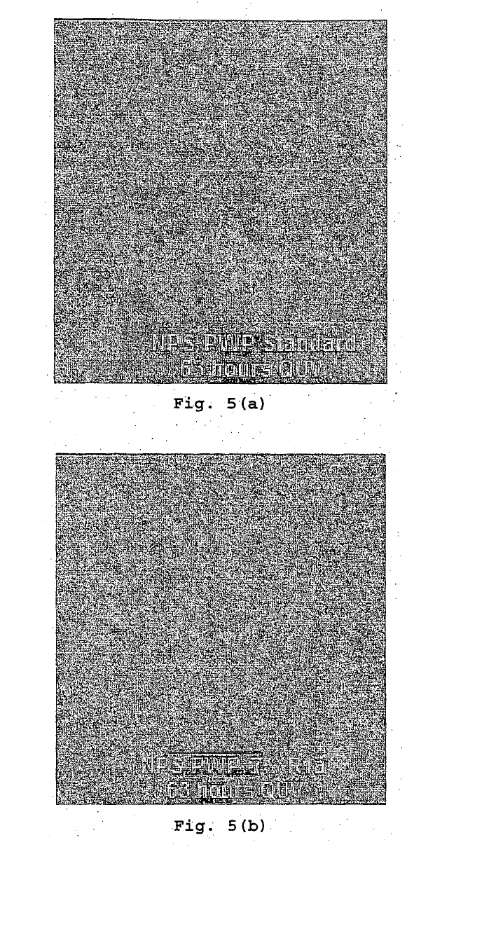

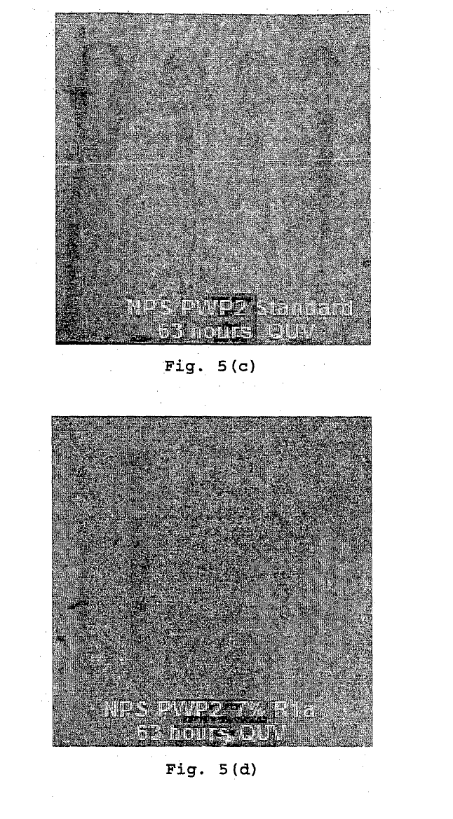

FIG. 4 is a schematic diagram showing a multi-functionalized dendritic polymer substituted with hydrophilic, curable and low surface tension functional groups such as carboxylic, acrylic and fluorocarbon functional groups, respectively. “n” is the number free hydroxyl groups and “x”, “y”, and “z” are the numbers of hydrophilic, curable, and low-surface tension functional groups, respectively. “n” is a non-negative integer, “x”, “y”, and “z” are positive integers. The sum of “n”, “x”, “y” and “z” equals the original number of hydroxyl groups on the dendritic polymer. “R¹”, “R²” and “R³” are the linkage groups for the three types of functional groups, respectively.

### EXAMPLES

Non-limiting examples of the invention and comparative examples will be further described in greater detail by reference to specific Examples, which should not be construed as in any way limiting the scope of the invention.

### Materials Used

Below is a list of the raw materials used in the following Examples. The commercial names (in bold) of the following raw chemicals will be used in the Examples for convenience.
1. Dendritic polymer with theoretically 16 peripheral hydroxyl groups, having a molecular weight of about 2100 g/mol, and a hydroxyl number of 490 to 530 mgKOH/g, (“Boltorn H20”) procured from Perstorp Singapore Pte Ltd.
2. Dendritic polymer with theoretically 32 peripheral hydroxyl groups, having a molecular weight of about 3500 g/mol, and a hydroxyl number of 480 to 520 mgKOH/g, (“Boltorn H30”) procured from Perstorp Singapore Pte Ltd.
3. Dendritic polymer with theoretically 64 peripheral hydroxyl groups, having a molecular weight of about 5100 g/mol, and a hydroxyl number 470 to 500 mgKOH/g, (“Boltorn H40”) procured from Perstorp Singapore Pte Ltd.
4. Polydimethylsiloxane with terminal hydroxylalkyl groups, having a linear structure with a very low molecular weight and having hydroxyl groups by weight of about 6 percent (“Baysilone® OF-OH502 6%”), procured from Momentive, United States of America.
5. Ethoxylated perfluoropolyether with hydroxyl end groups (“Fluorolink E10-H”), procured from Solvay, Belgium.
6. Fluoropolymer with alternating fluoroethylene and alkyl vinyl ether segments having a hydroxyl number of about 52 mgKOH/g (“Lumiflon LF200”), procured from Asahi Glass Co Ltd, Japan.
7. Photoinitiator comprising a 1:1 mixture by weight of 1-hydroxy-cyclohexyl-phenyl-ketone and benzophenone (“Irgacure 500”), procured from BASF, United States of America.
8. Trimethyl benzoyldiphenylphosphine oxide which is available as a white viscous liquid (“Esacure DP250”).
   It is a stable water emulsion based on 32 percent of active photoinitiator, easily dispersible in aqueous medium, procured from Lehmann & Voss & Co., Germany.
      Other reagents such as hexahydrophthalic anhydride (HHPA), N-cyclohexyl-3-aminopropanesulfonic acid (CAPS), isophorone diisocyanate (IPDI), 2-hydroxyethyl acrylate (HEA), dipropylene glycol dimethyl ether (DMM), dibutylin dilaurate (DBTDL), 2-(perfluorooctyl)ethanol, maleic anhydride (MA), succinic anhydride (SA), itaconic anhydride (IA) and butylated hydroxyltoluene (BHT) were purchased from Sigma-Aldrich, United States of America. N,N-dimethylcyclohexylamine was purchased from Alfa Aesar, United Kingdom.

### Example 1

### Preparation of IPDI Adducts

(1a) Preparation of the CAPS Adduct with IPDI In a nitrogen atmosphere, a mixture of IPDI (5.00 g), DMM (25.74 g), N,N-dimethylcyclohexylamine (2.87 g) and CAPS (5.00 g) were stirred at 80° C. for 1.5 hours until all solids were dissolved. The resultant mixture separated into two immiscible layers upon standing at 80° C. Upon cooling down to room temperature, the CAPS-IPDI adduct separated out as a waxy layer, which was used within 1 day.

(1b) Preparation of the HEA Adduct with IPDI

In a dry air atmosphere, HEA (38.2 g) was added dropwise, over 40 minutes, to a mixture of IPDI (76.8 g), DMM (40.0 g), BHT (0.078 g) and DBTDL (0.15 g), at 25° C.

(1c) Preparation of the Fluorolink E10-H™ Adduct with IPDI

In a nitrogen atmosphere, a solution of IPDI (1.50 g) in DMM (12.0 g) was added slowly, over 10 minutes, to a mixture of Fluorolink E10-H™ (12.2 g), DMM (12.0 g) and DBTDL (0.040 g) with vigorous stirring at 25° C. The mixture was stirred at 25° C. for a further 1.5 to 2 hours until the theoretical percentage of isocyanate (NCO %) (about 0.75 percent) was obtained. The mixture obtained had a Fluorolink E10-H™ content of about 32 percent by weight, and was used immediately.

(1d) Preparation of the Fluorolink E10-H™ Adduct with 2(IPDI)

In a nitrogen atmosphere, Fluorolink E10-H™ (12.1 g) was added slowly, over 30 minutes, to a mixture of IPDI (3.0 g), DMM (24.0 g) and DBTDL (0.020 g) with vigorous stirring at 25° C. The resulting mixture was stirred at 25° C. for a further 10 minutes until the theoretical NCO % (about 1.45 percent) was obtained. The mixture obtained had a Fluorolink E10-H™ content of about 31 percent by weight, and was used within 1 day.

(1e) Preparation of the Lumiflon™ LF200 Adduct with IPDI

In a nitrogen atmosphere, Lumiflon™ LF200 (20.2 g) dissolved in DMM (20.2 g)was added dropwise, over 15 minutes, to a mixture of IPDI (2.50 g) and DMM (2.50 g) and DBTDL (0.45 g) at 20° C. The mixture was stirred at 20° C. for a further 10 minutes until the theoretical NCO % (about 2.08 percent) was obtained. The resultant clear solution was used within 1 day.

(1f) Preparation of the 2-(perfluorooctyl)ethanol Adduct with IPDI

In a nitrogen atmosphere, 2-(perfluorooctyl)ethanol (6.26 g) was added slowly to a mixture of IPDI (3 g), DMM (24 g) and DBTDL (0.020 g) at room temperature with vigorous stirring. The mixture was stirred at room temperature until the theoretical NCO % (2.67 percent) was obtained.

(1g) Preparation of the 2 (Baysilone™ OF-OH502 6%) Adduct with IPDI

In a nitrogen atmosphere, a solution of Baysilone™ OF-OH502 6% (20 g) dissolved in DMM (20 g) was added slowly, over 10 minutes, to a mixture of IPDI (13.47 g), DMM (13.47 g) and DBTDL (33 mg) at 20° C. with stirring. The temperature of the reaction was maintained between 20 and 25° C. using a water bath. The mixture was stirred for another 30 minutes until the theoretical NCO % (about 3.80 percent) was obtained. The resultant clear solution was used within 1 day.

### Example 2

Preparation of Dendritic Polymers Substituted with Carboxylic Acids

In a nitrogen atmosphere, the dendritic polymer (Boltorn H20™, Boltorn H30™ or Boltorn H40™) (50 g) and DMM (50 g) were heated in an oil bath at 140° C. with vigorous stirring for about 20 minutes until the polymer melted and a cloudy emulsion was obtained. The resulting mixture was cooled down to 120° C. and HHPA (17.5 g) was added in one portion. The mixture was stirred at 120° C. for a further 1 hour until all the anhydride was consumed, as monitored by Fourier Transform Infrared (FTIR) spectroscopy (anhydride characteristic absorption frequencies are at about 1850 cm⁻¹ and 1780 cm⁻¹). About 25 percent of the hydroxyl groups were esterified in the resultant dendritic polymer.

### Example 3

Preparation of Dendritic Polymers Substituted with Caprolactone

(3a) Preparation of Dendritic Polymers Substituted with Carboxylic Acids and Caprolactone

In a nitrogen atmosphere, the dendritic polymer (Boltorn H20™, Boltorn H30™ or Boltorn H40™) (50 g) and DMM (50 g) were stirred in an oil bath at 140° C. with vigorous stirring for about 20 minutes until the polymer melted and a cloudy emulsion was obtained. To the resulting mixture, caprolactone (50 g) was added in one-portion. The mixture instantly became a clear solution and was stirred for a further 1 to 2 hours until all caprolactone was consumed, as monitored by Gas Chromatography (GC). The resulting mixture was cooled down to 120° C. and HHPA (17.2 g, 25 OH %) was added in one portion. The mixture was stirred at 120° C. for a further 1 hour until all the anhydride was consumed, as monitored by Fourier Transform Infrared (FTIR) spectroscopy.

(3b) Preparation of Dendritic Polymers Substituted with CAPS and Caprolactone

In a nitrogen atmosphere, the dendritic polymer (Boltorn H20™, Boltorn H30™ or Boltorn H4O™) (48.0 g) and DMM (48.0 g) were stirred in an oil bath at 140° C. with vigorous stirring for about 20 minutes until the polymer melted and a cloudy emulsion was obtained. To the resulting mixture, caprolactone (16.0 g) was added in one-portion. The mixture instantly became a clear solution and was stirred for a further 1 hour until all caprolactone was consumed, as monitored by Gas Chromatography (GC). The resulting mixture was cooled down to 80° C. to which the suspension of the CAPS adduct with IPDI, as prepared in Example (1a), was added over 5 minutes while still warm. The resultant mixture was stirred at 80° C. until NCO % was below 0.1 percent.

### Example 4

General Procedure for Preparation of Dendritic Polymers Substituted with Carboxylic Acids and Acrylates

In a dry air atmosphere, a mixture of carboxylic acid-substituted dendritic polymer, such as those as prepared in Example 2 and Example 3 (258 g) and DBTDL (0.26 g) was heated in an oil bath to 80° C. with stirring while dry air was bubbled into the reaction mixture throughout the entire process of the preparation. To this, the HEA adduct with IPDI, as prepared in Example (1b) (112 g), was added over 30 minutes. The mixture was stirred at 80° C. for a further 30 minutes until the NCO % was less than 0.1 percent. The product was then allowed to cool to room temperature.

### Example 5

Preparation of Dendritic Polymers Substituted with Carboxylic Acids, Acrylates and Fluorocarbons

In a dry air atmosphere, the dendritic polymer obtained in Example 4 was heated to 80° C. with dry air bubbling into the reaction mixture throughout the entire process of the preparation. The fluorocarbon adduct with IPDI, as prepared in Examples (1c) to (1f) was added slowly, over 10 minutes, to the mixture with vigorous stirring. The mixture was stirred at 80° C. for a further 30 minutes. The product was then allowed to cool to room temperature to yield a cloudy mixture.

### Example 6

A General Procedure for the Neutralization of Dendritic Polymers Substituted with Carboxylic Acids

The dendritic polymer (10 g) was mixed with a 10 percent aqueous sodium hydroxide solution to give a pH value of about 7 to 8. The final polymer concentration was adjusted to about 40 percent solid content by weight using deionized water.

### Example 7

A list of some representative dendritic polymers synthesized with various functional groups are shown in Table 1.

TABLE 1
A list of some representative dendritic polymers.

| | | | | Low surface |
|---|---|---|---|---|
| Function- | Caprolactone | | | tension func- |
| alized | (wt % to | hydrophilic | Acrylic | tional group |
| dendritic | dendritic | groups | groups | (wt % based |
| polymer | polymer) | (OH %)^{a} | (OH %)^{a} | on NVC)^{b} |
| R1 | — | 25, MA | 25 | — |
| R1a | — | 25, MA | 25 | 2, 1d |
| R1c | — | 25, MA | 37.5 | 2, 1d |
| R2 | — | 35, MA | 25 | — |
| R2a | — | 35, MA | 25 | 2, 1d |
| R3 | — | 45, MA | 25 | — |
| R3a | — | 45, MA | 25 | 2, 1d |
| R4 | — | 25, HHPA | 25 | — |
| R4a | — | 25, HHPA | 25 | 2, 1d |
| R4b | — | 25, HHPA | 37 | — |
| R4c | — | 25, HHPA | 37 | 2, 1d |
| R4d | — | 25, HHPA | 25 | 2, 1c |
| R4e | — | 25, HHPA | 25 | 5, 1c |
| R4f | — | 25, HHPA | 25 | 2, 1e |
| R4g | — | 25, HHPA | 25 | 2, 1d |
| R4h | — | 25, HHPA | 25 | 2, 1f |
| R4i | — | 25, HHPA | 25 | 2, 1g |
| R5 | — | 25, SA | 25 | — |
| R5a | — | 25, SA | 25 | 2, 1d |
| R6 | 100 | 25, HHPA | 25 | 2, 1c |
| R7 | 200 | 25, HHPA | 25 | 2, 1c |
| R8 | 200 | 25, IA | — | 2, 1e |
| R9 | 33 | 10, CAPS | 25 | — |
| R9a | 33 | 10, CAPS | 25 | 2, 1c |
| R9c | 33 | 10, CAPS | 25 | 2, 1f |
| R9d | 33 | 10, CAPS | 25 | 5, 1f |
| R10 | 33 | 10, CAPS | 35 | — |
| R10a | 33 | 10, CAPS | 35 | 2, 1c |
| R10b | 33 | 10, CAPS | 25 | 2, 1f |

^{a}Equivalent in percentage to the original total hydroxyl groups on the dendritic polymer
^{b}1c-1g are products described in Examples 1c-1g, respectively.

### Example 8

### UV Curing Studies of the Polymer Compositions

The functionalized dendritic polymers were found to be easily cured under UV radiation in the presence of a photoinitiator. The curing process was monitored by Attenuated Total Reflectance (ATR)-FTIR. In a typical formulation, the functionalized dendritic polymer was mixed with 3 percent by weight of Irgacure® 500, diluted with DMM to about 50 percent NVC, and cast onto a glass or iron panel. The panel was allowed to stand at room temperature for 15 minutes and then at 55° C. for 5 minutes, followed by UV irradiation using a Dymax UV curing system (5000-EC Series, Flood Lamp) for 10 to 90 seconds. ATR-FTIR clearly showed that the intensity of the characteristic acrylic C═C double bond absorption peak at 810 cm⁻¹ decreased with UV irradiation and disappeared when the film was fully cured.

### Comparative Example 1

TABLE 2
A comparison of the pencil hardness of some
of the functionalized dendritic polymers.

| Function- | | |
|---|---|---|
| alized | | |
| dendritic | Pencil hardness | MEK double rub test |
| polymer | (break/mark) | (cycles) |
| R3 | 4H/2H | 114 |
| R3a | H/H | 215 |
| R4b | H/2H | 49 |
| R4c | F/HB | 50 |

Table 2 shows the pencil hardness and MEK double rub test results of the films prepared by UV curing in a similar manner described in Example 8 The results clearly show that the functionalized dendritic polymers can be cured with UV radiation.

### Comparative Example 2

### Evaluation of Contact Angles of UV Cured Polymers

The water contact angles of the UV cured polymers were measured. Films of the polymer compositions were prepared in a similar manner to that described in Example 8. The water contact angle was measured at room temperature using a Rame-Hart NRL-100-00 goniometer equipped with a CCD camera. 3 mu·L deionized water was added onto the film by an autodispensing system. The high resolution camera and software were used to capture the profile of the liquid on the film and its contact angle was analyzed. At least 3 measurements were conducted for each sample and the average value was recorded.

TABLE 3
A table showing the contact angles of the UV-cured polymers.

| Function- | |
|---|---|
| alized | |
| dendritic | Contact angles |
| polymer | (degree, water) |
| R1 | 78.5 |
| R1a | 109.6 |
| R2 | 89.44 |
| R2a | 107.11 |
| R3 | 79.39 |
| R3a | 106.71 |
| R5 | 91.17 |
| R5a | 115.53 |

As shown in Table 3, polymer compositions before neutralization, that contained functionalized dendritic polymers that had been substituted with fluorocarbons (R1a, R2a, R1a and R5a), showed significantly larger water contact angles, suggesting higher hydrophobicity due to incorporation of low surface tension functional groups. Furthermore, without the neutralization step to cause ionization of the ionizable functional groups, the hydrophilic effect of the film is minimized.

### Comparative Example 3

### Evaluation of Resistance to Dirt Pick-Up

Resistance to dirt pick-up was evaluated with a carbon black spray test. Dymax UV curing system (5000-EC Series, Flood Lamp) was used as the UV radiation source, ATR-FTIR was used to monitor the UV curing process and the colour measurements were carried out using the BYK Gardner Spectro-Guide 45/0 Color Spectrophotometer.

The neutralized functionalized dendritic polymer (3g), as prepared in Example 6, and Irgacure® 500 (0.3 g) were mixed thoroughly with a commercial latex paint (97 g) and cast onto glass panels (200 mm×75 mm) with a 100 mu·m applicator. The panels were dried in air for about 24 hours at room temperature, then irradiated with UV light for 90 seconds (total energy=25.8 Jcm⁻², total power=0.29 Wcm⁻²). Before application of the carbon black spray, colour measurements were conducted for all coated glass panels and L*ᵥₐₗᵤₑₛ (as defined in CIE L*a*b*) were recorded (L*_{before}). The panels were place vertically and were sprayed 25 times in 30 seconds with carbon black suspension in water (0.5 percent Colanyl Black N-131) such that the spray covered the whole surface of the panel. After standing for a few minutes, the panels were rinsed with running tap water (4 L per minute) for 30 seconds. The panels were dried and the L* values were measured again L*_{after}).

The difference in L* values between two measurements, ΔL*, was calculated according to the equation ΔL*=L*_{before}−L*_{after}, indicating the dirt pick-up resistance performance. A lower ΔL* means better performance. The improvement of dirt pick-up resistance by addition of the functionalized dendritic polymer was calculated in percentage relative to the control (i.e. without addition of the functionalized dendritic polymer) according to the equation:

Improvement (%)=(ΔL*_{control}−ΔL*)/ΔL*_{control}

TABLE 4
A table showing the dirt pick-up properties of
coatings mixed with the functionalized dendritic polymers.

| | |
|---|---|
| | Dirt pick-up resistance |
| Paint and | Improvement(%)^{b} |

| functionalized | Before UV | After UV |
|---|---|---|
| dendritic polymer^{a} | radiation | radiation |
| 5A + 3% R1 | 5.6 | 30 |
| 5A + 3% R1a | 54.9 | 56.6 |
| 5A + 3% R4c | 51.5 | 35.4 |
| 5A + 3% R4d | 86.8 | 67.7 |
| 5A + 3% R4e | 92.6 | 86.8 |
| 8A + 3% R1 | 49.4 | 22.7 |
| 8A + 3% R1a | 69.8 | 55.0 |
| 8A + 3% R4c | 53.4 | 50.7 |
| 8A + 3% R4d | 63.9 | 60.6 |
| 8A + 3% R4e | 64.3 | 65.4 |

^{a}Commercial latex paint 5A: NPS polymeric WP exterior paint, procured from Nippon Paint Singapore; Commercial latex paint 8A: NPM Weatherbond exterior paint, procured from Nippon Paint Malaysia.
^{b}Calculated according to the equation: Improvement (%) = (ΔL*_{control} − ΔL*)/ΔL*_{control}

### Comparative Example 4

### Evaluation of Paint Film Surface

The effect of adding the inventive dendritic polymer to paint was studied by evaluating the contact angles of the paint film. The commercial latex paint 5A from Comparative Example 3 was mixed with the neutralized dendritic polymer R1a (3 percent by weight) then cast onto glass panels and dried. A significant decrease in contact angles was observed following addition of the functionalized dendritic polymer as shown in Table 5. X-ray photoelectron spectroscopy (XPS) studies also showed high concentration of fluorine at the paint film surface. After flushing with water for 5 minutes, the contact angles and fluorine atom content of the paint films were shown to be almost unchanged. It is interesting to note, however, that after UV radiation, the water contact angles and fluorine atom content on the surface of the paint film decreased, suggesting that a possible surface morphology change occurred upon curing, which may have caused the paint film surface to become more hydrophilic.

Further, when the films were flushed with water for 2 hours, the fluorine atom content of the films that had been cured by UV irradiation remained almost unchanged, whereas the fluorine atom content in the films without UV curing decreased by 33 percent from 5.14 percent to 3.44 percent. These results indicate that after UV curing, the cross-linkable functional groups on the dendritic polymer may aid in fixing the other functional groups such as the low surface tension functional groups on the dendritic polymer to the surface of the coating film.

TABLE 5
A table showing the water contact angle and fluorine atom content
of the paint film surface following various treatments.

| Paint and | Contact Angles | Fluorine atom |
|---|---|---|
| functionalized | (degree, | content |
| dendritic polymer | water) | (atom %)^{a} |
| 5A | 74.6 | 0.10 |
| 5A, flushed with water | 76.4 | 0 |
| for 5 minutes | | |
| 5A with UV radiation | 77.7 | 0.13 |
| 5A with UV radiation, | 74.4 | 0.10 |
| flushed with water | | |
| for5 minutes | | |
| 5A and 3% R1a | 61.4 | 5.14 |
| 5A and 3% R1a, flushed | 69.5 | 5.02 |
| with water for 5 | | |
| minutes | | |
| 5A and 3% R1a, flushed | — | 3.44 |
| with water for 2 hours | | |
| 5A and 3% R1a with UV | 56.6 | 2.33 |
| radiation | | |
| 5A and 3% R1a with UV | — | 2.21 |
| radiation, flushed | | |
| with water for 2 hours | | |

^{a}atomic % of elemental fluorine among 4 elements (C, N, O, F) determined by XPS.

### Comparative Example 5

### Dirt-Water-Streak Mark Testing

Two types of latex Weatherbond paint PWP1 and PWP2 (kindly supplied by Nippon Paint Singapore) were selected to evaluate the Dirt-water-streak-mark resistance following addition of dendritic polymer R1a.

Neutralized dendritic polymer R1a was added to PWP1 or PWP2 at an amount of 7 percent by weight. The coating composition was painted on a cement fiber board, with 1 coat of a sealer basecoat and 2 coats of a topcoat of the coating composition. Each coat was allowed to dry at 28° C. and 65 percent relative humidity for at least 4 hours before application of the next coat. After that the panels were conditioned at 28° C. and 65 percent relative humidity for 12 hours before they were exposed to a QUV Accelerated Weather Tester machine for 60 hours, which comprised 7.5 cycles of UV-B exposure for 4 hours and 4 hours of condensation per cycle.

The dirt solution used was a 1 percent solution of the in-house dirt composition. The in-house dirt-composition was composed of about 3 parts JIS class 8 dust (fine grain, defined by JIS Z 8901) and about 1 part inorganic powder. The inorganic powder was an inorganic salt such as sodium chloride, magnesium oxide or iron oxide. The dirt solution was circulated and allowed to flow as a stream over the testing panels for 60 minutes. The appearance of the panels were then visually compared and assessed for dirt streak marks.

FIG. 5 shows photographs comparing paint samples with and without the addition of the dendritic polymer R1a. FIG. 5(a) shows PWP1 without R1a, FIG. 5(b) shows PWP1 with R1a addition, FIG. 5(c) shows PWP2 without R1a and FIG. 5(d) shows PWP2 with R1a addition. FIG. 5 shows that the cement fiber boards coated with the paint composition containing the hyperbranched dendritic polymer (R1a) at 7 wt % (FIGS. 5(b) and 5(d)) have superior dirt-water-streak-mark resistance relative to comparative coating PWP1 (FIG. 5(a)) and PWP2 (FIG. 5(c)), respectively, which did not contain the hyperbranched dendritic polymer (R1a).

### Comparative Example 6

### Latex Paint Film Gel Content Study:

The effect of adding the functionalized dendrimer to the gel content of latex was studied. The pure elastomeric latex 9A was kindly provided by Nippon Paint Singapore. The Latex 9A was mixed with the neutralized polymeric dendrimer R1a at an amount of 7.5 weight percent and the photoinitiator Irgacure® 500 or Esacure® DP250 at an amount of 0.32 weight percent. The polymer compositions were then cast onto glass panels to obtain a wet film thickness of about 10 mu·m. The film was allowed to dry at room temperature for 10 minutes to let the solvents evaporate, followed by placing it in a 55° C. oven for 30 minutes. This was done to ensure that fast evaporation of the solvents resulted in a coating film. The film was then placed in a UV Fusion machine and exposed to DV with a total energy of 24 Jcm⁻² and total power of 4 Wcm⁻². The dry film was conditioned at 25° C. and 70 percent humidity for 7 days to ensure homogenization of the film and to eliminate the effect of different environments on the performance of the film, before conducting the gel content test. The same procedure was repeated with pure Latex 9A (without the addition of dendritic polymer R1a) as a control sample.

The dry film was covered by filer paper the sample was weighed to record the weight (W1). The sample was soaked in acetone with consistent stirring at 25° C. for 3 hours. After that, the sample was removed and dried at 110° C. for 2 hours to remove any solvent. The sample was weighed again and the weight (W2) was recorded. Gel Content was calculated using the formula: Gel Content(%)=(W2/W1)×100.

Table 6 shows that following addition of dendritic polymer R1a into Latex 9A and exposure to UV light, the gel content of the latex film greatly increased from 74.36 percent to about 87.67 percent or 88.10 percent using Irgacure® 500 or Esacure® DP250, respectively, as the photoinitiator. The increase of gel content of the latex film indicates the cross-linking of R1a with 9A.

TABLE 6
A table showing the effect of adding the dendritic
polymer to the gel content of latex.

| Sample Code | Sample composition | Gel Content (%) |
|---|---|---|
| L13006 | Latex 9A | 74.36 |
| L13008 | Latex 9A + 7.5 wt % | 87.67 |
| | R1a + 0.32 wt % Irgacure ® | |
| | 500 | |
| L13010 | Latex 9A + 7.5 wt % | 88.10 |
| | R1a + 0.32 wt % DP250 | |

### Comparative Example 7

### Evaluation of the Water Contact Angle and Organic Contact Angle of the Paint Film Surface

TABLE 7
A table showing the water contact angle and hexadecane contact angle
of the paint film surface before and after UV cross-linking.

| Paint with | Contact Angles | Contact Angles |
|---|---|---|
| functionalized | (degree, | (degree, |
| dendritic polymer | water) | hexadecane) |
| 5A with UV radiation | 76.2 | 5.2 |
| 5A and 3% R4e, with UV | 53.5 | 66.4 |
| radiation | | |
| 5A and 7% R4e with UV | 55.4 | 66.3 |
| radiation | | |

As shown in Table 7, addition of functionalized polymer R4e to the paint caused the contact angle of hexadecane to dramatically increase from 5.2° to 66°. A larger hexadecane contact angle indicates lipophobic, or oleophobic properties of the coating film. The lipophobic, or oleophobic properties improve the hydrophobic dirt pick-up resistance of the surface of the coating film.

In contrast, the addition of functionalized polymer R4e to the paint caused the contact angle of water to decrease from 76.7° to 53.5°. A larger water contact angle indicates better hydrophobicity. Although some decrease in contact angle of water was observed, this decrease was not significant as to compromise the hydrophilic properties of the film. That is, the film, even with an improvement in oleophobic properties, is also sufficiently hydrophilic such that dirt may be washed away by running water.

### Applications

The disclosed aqueous dispersible dendritic polymer composition may have superior resistance to dirt pick-up, cracking and formation of water streak marks.

The disclosed aqueous dispersible dendritic polymer composition may contain dendritic polymers that form high performance coatings.

The disclosed aqueous dispersible dendritic polymer composition may provide coatings that are water dispersible such that emission of an undesirably high level of volatile organic compounds (VOC), which may be flammable, emit an odor and be harmful to health and/or the environment, may be eliminated.

The disclosed aqueous dispersible dendritic polymer composition may be sufficiently hydrophilic to enable a film comprising the dendritic polymer composition to be washable.

The disclosed aqueous dispersible dendritic polymer composition may have lower surface energy such that water and oil repellency, crucial factors for dirt pick-up resistance, is increased.

The disclosed aqueous dispersible dendritic polymer composition may provide lower surface energy coatings where the dirt-resistant component will not be washed away in the presence of running water.

The disclosed aqueous dispersible dendritic polymer composition may readily undergo radiation curing.

The disclosed aqueous dispersible dendritic polymer composition may have superior film-forming properties.

The disclosed process for preparing an aqueous dispersible dendritic polymer composition may have useful applications in the preparation of other polymers and dendritic polymers.

Accordingly, the disclosed aqueous dispersible dendritic polymer composition may be used to prepare coatings or be included as additives to coatings for numerous applications, including but not limited to, protective coatings for automotive, protective coatings for paints, furniture, air-craft parts, household appliances and electronic devices.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1) A dendritic polyester polymer comprising low surface tension functional groups, curable functional groups and hydrophilic functional groups; wherein each of the functional groups are functionally different from each other; each of the functional groups are covalently bonded to the dendritic polymer; and the hydrophilic functional groups are present in an amount to render the dendritic polymer dispersible in an aqueous medium.

2) The dendritic polymer as claimed in claim 1, wherein at least 10 percent of the functional groups present on the dendritic polymer are hydrophilic groups.

3) (canceled)

4) The dendritic polymer as claimed in claim 1, wherein the low surface tension functional groups comprise at least 0.1 percent by weight of the total non-volatile content.

5) (canceled)

6) The dendritic polymer as claimed in claim 1, wherein said hydrophilic functional group is selected from a group consisting of primary amino groups, secondary amino groups, tertiary amino groups, quaternary ammonium salt groups, amide groups, carboxyl groups, carboxylate groups, ethylene oxide groups, propylene oxide groups, ester groups, sulfonic acid groups, phosphoric acid groups and hydroxyl groups, said low surface tension functional group is selected from the group consisting of fluorinated groups and silicon groups and said curable functional group is a radiation curable cross-linking group.

7) (canceled)

8) (canceled)

9) The dendritic polymer as claimed in any one of the preceding claim 1, further comprising softening functional groups or lactones of a hydroxyl carboxylic acid.

10) (canceled)

11) A polymer composition comprising the dendritic polymer of claim 1, further comprising at least one additive, selected from the group consisting of a photoinitiator, a UV-stabilizer, a metal oxide nanoparticle and any mixture thereof.

12) A method for preparing a functionalized dendritic polyester polymer comprising low surface tension functional groups and hydrophilic functional groups, comprising the steps of;
a) covalently functionalizing a dendritic polymer with low surface tension functional groups using a low surface tension functionalizing agent;
b) covalently functionalizing a dendritic polymer with hydrophilic functional groups using a hydrophilic functionalizing agent in an amount to render the dendritic polymer dispersible in an aqueous medium; and
c) covalently functionalizing the dendritic polymer with curable groups using a curable functionalizing agent;
each of the functional groups are functionally different from each other.

13) The method as claimed in claim 12, wherein steps (a) and (b) are performed separately.

14) The method as claimed in claim 12, wherein the dendritic polymer is a hydroxyl terminated polyester comprising peripheral hydroxyl functional groups.

15) The method as claimed in claim 14, wherein step (b) comprises the step of substituting at least 10 percent of the peripheral hydroxyl functional groups present on the dendritic polymer with hydrophilic groups.

16) (canceled)

17) The method as claimed in claim 12, wherein the hydrophilic functionalizing agent is an anhydride of a dicarboxylic acid.

18) The method as claimed in claim 7, wherein step (a) comprises the step of functionalizing the dendritic polymer so that the low surface tension functional groups comprise at least 0.1 percent by weight of the total non-volatile content.

20) The method as claimed in claim 7, comprising the step of selecting the hydrophilic functional group from a group consisting of primary amino groups, secondary amino groups, tertiary amino groups, quaternary ammonium salt groups, amide groups, carboxyl groups, carboxylate groups, ethylene oxide groups, propylene oxide groups, ester groups, sulfonic acid groups, phosphoric acid groups and hydroxyl groups, said low surface tension functional group is selected from a group consisting of fluorinated groups and silicon groups, wherein said curable functional group is a radiation curable cross-linking group.

21) (canceled)

22) (canceled)

23) The method as claimed in claim 20, comprising the step of functionalizing the dendritic polymer with radiation curable cross-linking groups using a radiation curable cross-linking functionalizing agent.

24) The method as claimed in claim 12, wherein the hydrophilic functionalizing agent, the low surface tension functionalizing agent or the radiation curable cross-linking functionalizing agent is respectively an isophorone diisocyanate (IPDI), of a molecule comprising a hydrophilic functional group, a low surface tension functional group or a radiation curable cross-linking group, respectively.

25) The method as claimed in claim 12, further comprising the step of providing softening functional groups.

26) The method as claimed in claim 25, comprising the step of functionalizing the dendritic polymer with softening functional groups using a softening functionalizing agent or lactones of a hydroxyl carboxylic acid prior to functionalization with any other functional groups.

27) (canceled)

28) The method as claimed in claim 12, the method comprising the step of functionalizing the dendritic polymer with any functional group via a covalent bond using a functionalizing agent, selected from a group consisting of the hydrophilic functionalizing agent, the low surface tension functionalizing agent, the curable functionalizing agent and the softening functionalizing agent.

29) The method as claimed in claim 12, the method further comprising the step of at least partially neutralizing the dendritic polymer with a base.

30-35) (canceled)
